(19) United States
(12) Patent Application Publication
(10) Pub. No.: US 2008/0174280 A1
(43) Pub. Date: Jul. 24, 2008

(54) Unit including a circuit, device, and transmitting/receiving system

(76) Inventor: Masataka Kazuno, Chuo (JP)

Correspondence Address: HARNESS, DICKEY & PIERCE, P.L.C., P.O. BOX 828, BLOOMFIELD HILLS, MI, 48303, US

(21) Appl. No.: 11/903,757

(22) Filed: Sep. 24, 2007

(30) Foreign Application Priority Data
Sep. 26, 2006 (JP) 2006-261212
Sep. 13, 2007 (JP) 2007-237958

(51) Int. Cl. H02J 7/00; G06F 3/038

(52) U.S. Cl. 320/166; 345/204

(57) ABSTRACT

A unit including one or more circuits a first circuit includes a first circuit, a first capacitor, a charge storage, and a charge supplier. The first capacitor is for stabilizing operation of the first circuit. The charge storage stores an electrical charge prior to startup of the first circuit. The charge supplier charges the first capacitor at the time of startup of the first circuit, by means of supplying the first capacitor with the electrical charge stored in the charge storage.

### CROSS REFERENCE TO RELATED APPLICATIONS

This application relates to and claims priority from Japanese Patent Applications No. 2006-261212, filed on Sep. 26, 2006 and No. 2007-237958, filed on Sep. 13, 2007, the entire disclosure of which is incorporated by reference.

### BACKGROUND

1. Technical Field

The present invention relates to a unit including a circuit, to a device, and to a transmitting and receiving system; and relates in particular to a unit including a circuit, to a device, and to a transmitting and receiving system that respectively include a capacitor for the purpose of stabilizing operation.

2. Description of the Related Art

Electronic circuits are typically furnished with bypass capacitors for stabilizing their operation. In such electronic circuits, stable operation is afforded with the bypass capacitors in the charged state. Consequently, startup time equivalent to the time needed for charging the bypass capacitors will be required before the electronic circuit assumes a stable condition subsequent to initiating the supply of power.

With a view to reducing power consumption by electronic devices, it is common practice to supply the electronic circuits making up an electronic device with power only on an as-needed basis, halting the supply of power when not needed. In such cases, it will be desirable for electronic circuit startup time to be as short as possible. For example, a voltage regulator that during startup ceases operation of the current limiting circuit for a transistor that outputs electrical current, in order to shorten startup time, is known in the art.

However, according the voltage regulator mentioned above, the bypass capacitor is charged by means of excess current from the power supply during startup, thus posing the risk of increased power consumption at startup.

### SUMMARY

Aspects of the present invention is directed to addressing the above problem at least in part, and has as an object to attain a shorter startup time during startup of an electronic circuit, for example.

A first aspect of the present invention provides a unit including one or more circuits a first circuit. The unit pertaining to the first aspect comprises a first circuit, a first capacitor, a charge storage, and a charge supplier. The first capacitor is for stabilizing operation of the first circuit. The charge storage stores an electrical charge prior to startup of the first circuit. The charge supplier charges the first capacitor at the time of startup of the first circuit, by means of supplying the first capacitor with the electrical charge stored in the charge storage.

According to the unit pertaining to the first aspect, during startup of a first circuit, electrical charge stored in a charge storage is used to charge a first capacitor for stabilizing operation of the first circuit. As a result, for example, the time required to charge the first capacitor at startup of a first circuit can be shortened and power consumption at startup can be reduced.

The unit pertaining to the first aspect may further comprises a second circuit and the charge storage may be a second capacitor for stabilizing operation of the second circuit. By means of this arrangement, for example, the first capacitor can be charged rapidly using the charge stored in a second capacitor.

In the unit pertaining to the first aspect, in the event that the second circuit is started up when the first capacitor is charged, the charge supplier may additionally charge the second capacitor by means of supplying the second capacitor with the electrical charge stored in the first capacitor. By means of this arrangement, for example, the second capacitor can be charged rapidly using the charge stored in the first capacitor. Consequently, for example, the startup time of the second circuit can be shortened as well.

In the unit pertaining to the first aspect, the unit may operate in a first operation mode involving operation of the first circuit, and a second operation mode involving operation of the second circuit, and when operation of the unit transitions from the second operation mode to the first operation mode, the charge supplier may charge the first capacitor by means of supplying the first capacitor with the electrical charge stored in the second capacitor. By means of this arrangement, for example, the startup time of the first circuit can be shortened during transitioning of operation of the unit from a second mode to a first mode.

In the unit pertaining to the first aspect, when operation of the unit transitions from the second mode to the first mode, the charge supplier may additionally charge the second capacitor by means of supplying the second capacitor with the electrical charge stored in the first capacitor. By means of this arrangement, for example, the startup time of the second circuit can be shortened during transitioning of operation of the unit from the first mode to the second mode.

In the unit pertaining to the first aspect, the charge supplier may include a switch for switching a connection between an electrode of the first capacitor and an electrode of the second capacitor between a current-carrying state and an disconnected state, and a controller that controls the switch. By means of this arrangement, for example, the charge stored in the second capacitor can be readily supplied at arbitrary timing to the first capacitor, and used to charge the first capacitor.

In the unit pertaining to the first aspect, the first capacitor may be a bypass capacitor connected to a line for stabilizing a constant voltage, the line being for supplying the constant voltage with the first circuit, and the second capacitor may be a bypass capacitor connected to a line for stabilizing a constant voltage, the line being for supplying the constant voltage with the second circuit.

The unit pertaining to the first aspect may be a transmitting/receiving unit for transmitting/receiving signals with an another unit. In this case, the first circuit may include a circuit for transmitting or receiving a first signal, and the second circuit includes a circuit for transmitting or receiving a second signal, the second signal being slower than the first signal. By means of this arrangement, for example, it is possible to shorten the startup time of a circuit for transmitting or receiving high speed signals.

A second aspect of the present invention is a unit including one or more circuits, the unit comprising a first circuit, a first capacitor, a plurality of charge storages and a charge supplier. The first capacitor is for stabilizing operation of the first circuit. The plurality of charge storages store electrical charges prior to startup of the first circuit. The charge supplier charges the first capacitor at the time of startup of the first circuit, by means of supplying the first capacitor with the electrical charges stored in each of the plurality of charge storages at different timings.

According to the unit pertaining to the second aspect, during startup of a first circuit, a first capacitor is charged by each of the charge storages at different timings As a result, electrical charges stored in the plurality of charge storages are used effectively to charge a first capacitor, so the time required to charge the first capacitor can be shortened.

The unit pertaining to the second aspect may further comprises a second circuit and a third circuit, wherein the plurality of charge storages may include a second capacitor for stabilizing operation of the second circuit and a third capacitor for stabilizing operation of the third circuit. By means of this arrangement, for example, using the electrical charges stored in the second capacitor and third capacitor, the first capacitor can be promptly charged.

In the unit pertaining to the second aspect, the charge supplier may include a first switch for switching a connection between an electrode of the first capacitor and an electrode of the second capacitor between a current-carrying state and an disconnected state, a second switch for switching a connection between an electrode of the first capacitor and an electrode of the third capacitor between a current-carrying state and an disconnected state, and a controller that controls the first switch and the second switch. By means of this arrangement, for example, the charges stored in the second capacitor and the third capacitor can be readily supplied at arbitrary timing to the first capacitor, and used to charge the first capacitor.

In the unit pertaining to the second aspect, the first capacitor may be a bypass capacitor connected to a line for stabilizing a constant voltage, the line being for supplying the constant voltage with the first circuit, the second capacitor may be a bypass capacitor connected to a line for stabilizing a constant voltage, the line being for supplying the constant voltage with the second circuit, and the third capacitor may be a bypass capacitor connected to a line for stabilizing a constant voltage, the line being for supplying the constant voltage with the third circuit.

The unit pertaining to the second aspect may be a transmitting/receiving unit for transmitting/receiving signals with an another unit. In this case, the first circuit may include a circuit for transmitting or receiving a first signal, and the second circuit includes a circuit for transmitting or receiving a second signal, the second signal being slower than the first signal. By means of this arrangement, for example, it is possible to shorten the startup time of a circuit for transmitting or receiving high speed signals.

The present invention can be realized in various aspects, for example, a device comprising the unit of the above-mentioned aspects and a display driver adapted to drive a display device using the signal received by the unit. The invention can also be realized as a device comprising the unit of the above-mentioned aspects and a driver adapted to drive an electro optical device using the signal received by the unit. Furthermore, the invention can be realized as a transmitting/receiving system including a first transmitting/receiving unit and a second transmitting/receiving unit interconnected via signal lines. Furthermore, the invention is not to be considered limited to the apparatus-invention, may be realized as a method-invention. For example, the invention can be realized as a control method related to a first circuit.

The above and other objects, characterizing features, aspects and advantages of the invention will be clear from the description of preferred embodiments presented below along with the attached Figures.

### BRIEF DESCRIPTION OF THE DRAWINGS

FIG. 1 is a schematic diagram of the digital device in the embodiment;

FIG. 2 is an illustration depicting the internal configuration of the transmitting unit;

FIG. 3 is a diagram showing the principal constituent components of a data transmission circuit;

FIG. 4 is a diagram showing the data transmission circuit power supply and vicinity;

FIG. 5 is a schematic diagram depicting state transitions of the data transmission circuit;

FIG. 6 is a schematic diagram depicting differential signals and single end signals;

FIG. 7 depicts a control signal timing chart;

FIG. 8 is an illustration depicting the internal configuration of the receiving unit;

FIG. 9 is a diagram showing the principal constituent components of a data reception circuit;

FIG. 10 is a diagram showing the data reception circuit power supply and vicinity;

FIG. 11 is a schematic diagram depicting state transitions of the data reception circuit;

FIG. 12 depicts a control signal timing chart;

FIG. 13 is a graph illustrating startup time;

FIG. 14 is an illustration depicting the configuration of the vicinity of the power supply of the data reception circuit in Modification 4;

FIG. 15 is a diagram showing the data transmission circuit power supply and vicinity in Modification 5;

FIG. 16 depicts a control signal timing chart in Modification 5; and

FIG. 17 is a graph illustrating startup time in Modification 5.

### DETAILED DESCRIPTION OF THE PREFERRED EMBODIMENTS

The present invention will be described below on the basis of a embodiment, with reference to the accompanying drawings.

### Embodiment

### Configuration of Digital Device:

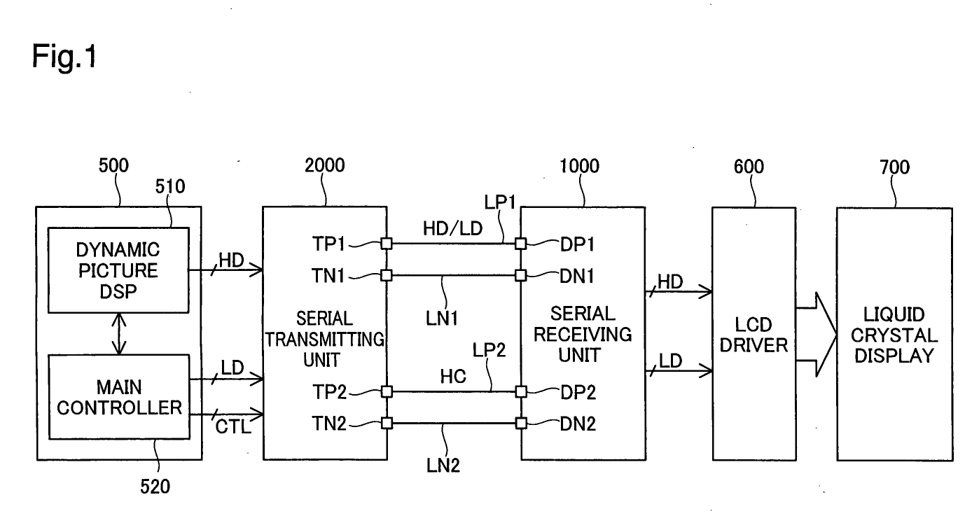

FIG. 1 is a schematic diagram of the digital device in the embodiment. As shown in FIG. 1, the digital device of the embodiment includes an image processing unit 500, a transmitting/receiving system composed of a transmitting unit 2000 and a receiving unit 1000, an LCD driver 600, and a liquid crystal display 700 as the display. This digital device is adapted for installation in electronic devices such as cell phones, and is used to display still picture images and dynamic picture images.

The image processing unit 500 performs image processing of image data acquired from other constitutional elements incorporated into the electronic device, for example, a wireless communication circuit or flash memory. The image processing unit 500 includes a DSP (Digital Signal Processor) 510, which is basically a computer specialized for image processing of dynamic image data; and a main controller 520 which is a computer for carrying out other processes (for example, processing of still images, and control processes for the LCD driver 600 and transmitting unit 2000).

The image processing unit 500 outputs to the transmitting unit 2000 data HD for transmission at high speed, and data LD for transmission at low speed. In the embodiment, the high speed transmission data HD is dynamic image data output by the DSP 500. In the embodiment, the low speed transmission data LD is data besides dynamic image data, for example, still image data or control data for the LCD driver 600. The image processing unit 500 also outputs a control signal CTL to the transmitting unit 2000.

The transmitting/receiving system composed of the receiving unit 1000 and the transmitting unit 2000 constitutes an interface for transmitting data LD, HD received from the image processing unit 500, to the LCD driver in accordance with the control signal CTL from the image processing unit 500. The transmitting unit 2000 has two pairs of transmission terminals for transmitting differential signals, namely, a terminal pair composed of terminals TP1, TN1 and a terminal pair composed of terminals TP2, TN2. The transmitting unit 2000 can also transmit a single end signal in addition to the differential signals from these terminals; this will be discussed later.

The receiving unit 1000 is provided with two pairs of transmission terminals corresponding respectively to the aforementioned terminal pairs, namely, a terminal pair composed of terminals DP1, DN1 and a terminal pair composed of terminals DP2, DN2. As shown in FIG. 1, the terminals TP1, TN1, TP2, TN2 of the transmitting unit 2000 and the corresponding terminals DP1, DN1, DP2, DN2 of the receiving unit 1000 are respectively connected by means of signal lines LP1, LN1, LP2, LN2. By means of this arrangement, the receiving unit 1000 can receive differential signals and single end signals from the transmitting unit 2000 via these signal lines.

The LCD driver 600 receives image data and control data from the image processing unit 500 via the transmitting/receiving system, and drives the liquid crystal display 700 on the basis of this data.

Configuration of the Transmitting Unit:

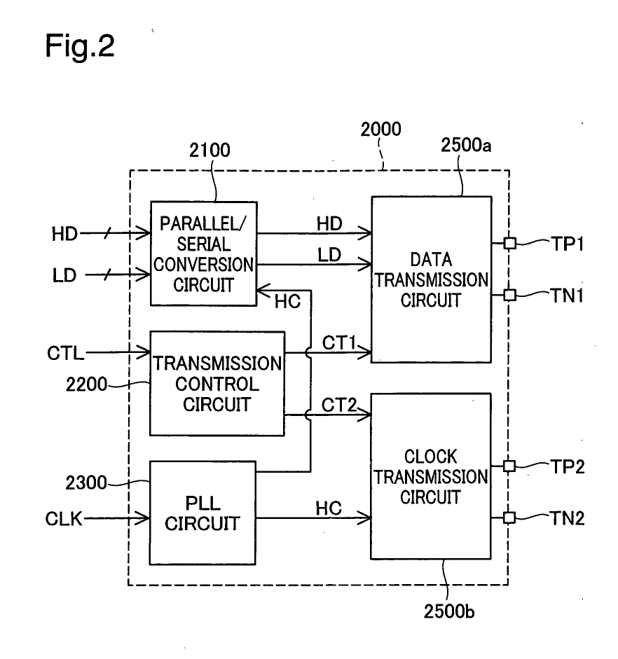

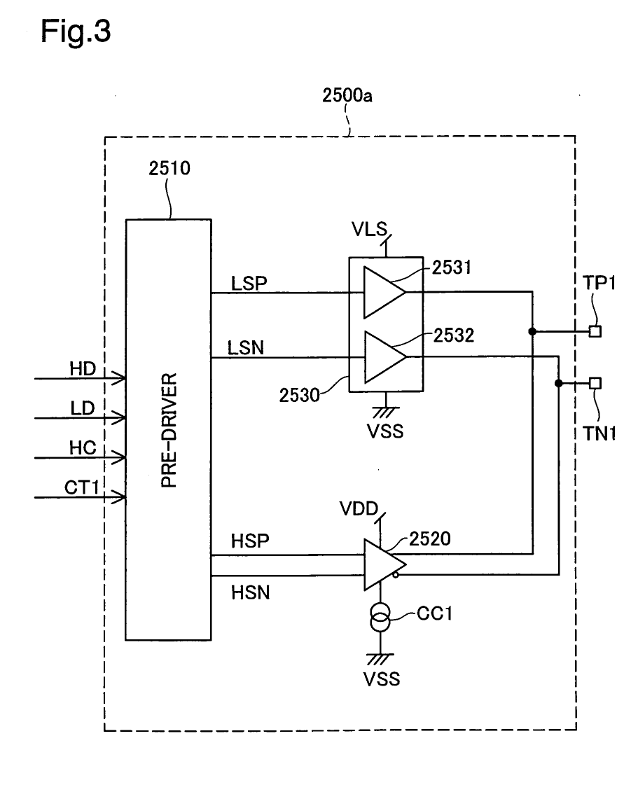

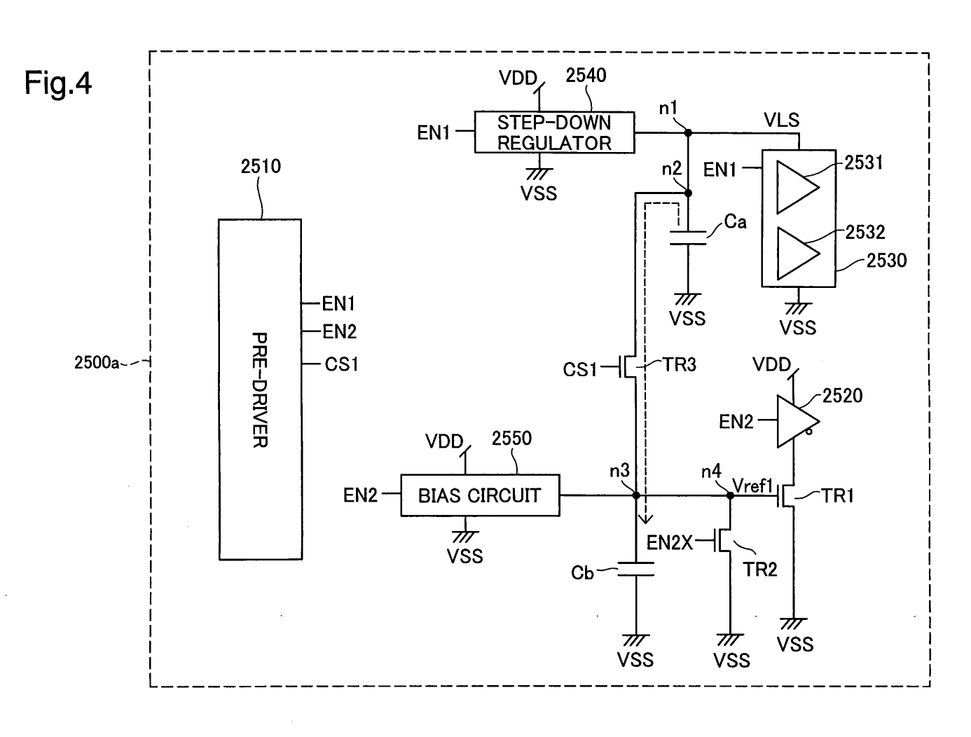

The transmitting unit 2000 will be discussed in greater detail with reference to FIGS. 2 through 4. FIG. 2 is an illustration depicting the internal configuration of the transmitting unit. FIG. 3 is a diagram showing the principal constituent components of a data transmission circuit. FIG. 4 is a diagram showing the data transmission circuit power supply and vicinity.

As shown in FIG. 2, in addition to the terminals TP1, TN1, TP2, TN2 mentioned earlier the transmitting unit 2000 includes a parallel/serial conversion circuit 2100, a transmission control circuit 2200, a PLL (Phase Locked Loop) circuit 2300, a data transmission circuit 2500a, and a clock transmission circuit 2500b. The PLL circuit 2300 receives a reference clock signal CLK and generates a high speed transmission clock HC. The parallel/serial conversion circuit 2100 converts parallel data HD, LD received from the image processing unit 500 into serial data which is sent to the data transmission circuit 2500a. The high speed transmission data HD undergoes parallel/serial conversion in sync with the high speed transmission clock HC. The transmission control circuit 2200 controls the data transmission circuit 2500a and the clock transmission circuit 2500b according to the control signal CTL from the image processing unit 500.

According to a control signal from the transmission control circuit 2200, the data transmission circuit 2500a performs either high speed transmission of the high speed transmission data HD or low speed transmission of the low speed transmission data LD. Specifically, as shown in FIG. 3, the data transmission circuit 2500a includes a differential driver 2520 and a single end signal driver 2530.

A pre-driver 2510 receives the high speed transmission data HD and a control signal CT1 indicating a high speed transmission request, and outputs signals HSP, HSN for driving the differential driver 2520. The signal HSP and the signal HSN have mutually opposite phases. The differential driver 2520 receives the signals HSP, HSN, and outputs differential signals over the signal lines LP1, LN1 via the terminals TP1, TN1. This sends the data HD, in the form of differential signals, to the receiving unit 1000. The differential driver 2520 includes a typical differential amplification circuit composed of a constant current supply and an n-channel field effect transistor, for example. Herein, a n-channel field effect transistor will be referred as an n transistor, and a p-channel field effect transistor will be referred as a p transistor. The differential driver 2520 is disposed between the power supply voltage VDD (in the embodiment, 1.8 V) and a reference voltage VSS (in the embodiment, ground voltage of 0 V), and is current-driven by a constant current supply CC1 similarly disposed between the power supply voltage VDD and the reference voltage VSS.

The pre-driver 2510 receives the low speed transmission data HD and a control signal CT1 indicating a low speed transmission request, and outputs signals LSP, LSN for driving the single end driver 2530. The single end driver 2530 is composed of a first single end transmission circuit 2531 that inputs the signal LSP, and a second single end transmission circuit 2532 that inputs the signal LSN. The first single end transmission circuit 2531 is a push-pull inverter circuit connected between an adjusting voltage VLS and the reference voltage VSS; in response to the drive signal LSP it outputs a single end signal over the signal line LP1 via the terminal LP1. The second single end transmission circuit 2532 is a push-pull inverter circuit connected between the adjusting voltage VLS and the reference voltage VSS; in response to the drive signal LSN it outputs a single end signal over the signal line LN1 via the terminal LN1. This sends the data LD to the receiving unit 1000, in the form of two single end signals.

As shown in FIG. 4, the data transmission circuit 2500a also includes a step-down regulator 2540 and a bias circuit 2550.

The step-down regulator 2540 steps down the input power supply voltage VDD (in the embodiment, 1.8 V) to the aforementioned adjusting voltage VLS (in the embodiment, 1.2 V) for output. The step-down regulator 2540 consists, for example, of a switching regulator that switches the input power and controls the output voltage by means of repeated ON/OFF operation of a power MOSFET or other semiconductor switch.

A capacitor Ca is disposed between the reference voltage VSS and a node n1 on the line over which the adjusting voltage VLS is output from the step-down regulator 2540 to the single end signal driver 2530. The capacitor Ca is a bypass capacitor for the purpose of stabilizing operation of the single end signal driver 2530.

The bias circuit 2550 uses the input power supply voltage VDD to generate a reference potential Vref1. The bias circuit 2550 is an ordinary band gap reference circuit, for example.

As shown in FIG. 4, an n transistor TR1 is disposed between the differential driver 2520 and the reference voltage VSS. The reference potential Vref1 is input to the gate of the n transistor TR1, whereby the n transistor TR1 functions as the constant current supply CC1 shown in FIG. 3.

Nodes n3 and n4 are disposed on the line over which the reference potential Vref1 is output from the bias circuit 2550 to the gate of the n transistor TR1. A capacitor Cb is disposed between the node n3 and the reference voltage VSS. The capacitor Cb is a bypass capacitor for the purpose of stabilizing the reference potential Vref1, and stabilizing the n transistor TR1 that functions as the constant current supply CC1. An n transistor TR2 is disposed between the node n4 and the reference voltage VSS. An inverted signal EN2X of an Enable signal EN2, discussed later, is input to the gate of the n transistor TR2, whereby the n transistor TR2 functions as a switch for switching, between an Enabled state and a Disenabled state, the n transistor TR1 that functions as the constant current supply CC1.

The node n2 connected to the electrode of the capacitor Ca and the node n3 connected to the electrode of the capacitor Cb are interconnected via an n transistor TR3. A control signal CS1 is input to the gate of the n transistor TR3, whereby the n transistor TR3 functions as a switch for switching the connection between the capacitor Ca and the capacitor Cb between a current-carrying state and an disconnected state.

Operation of the Transmitting Unit:

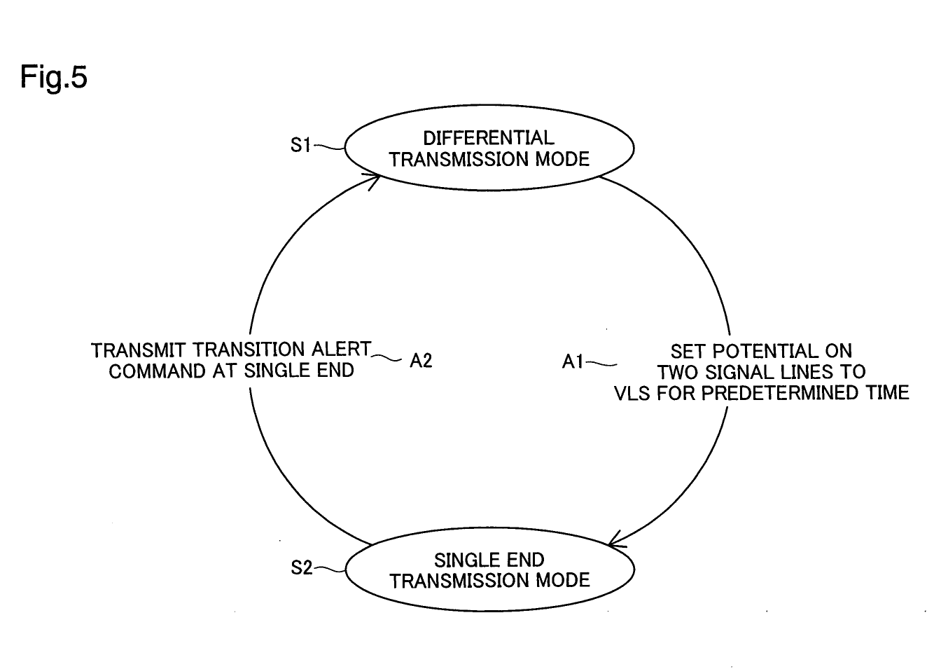

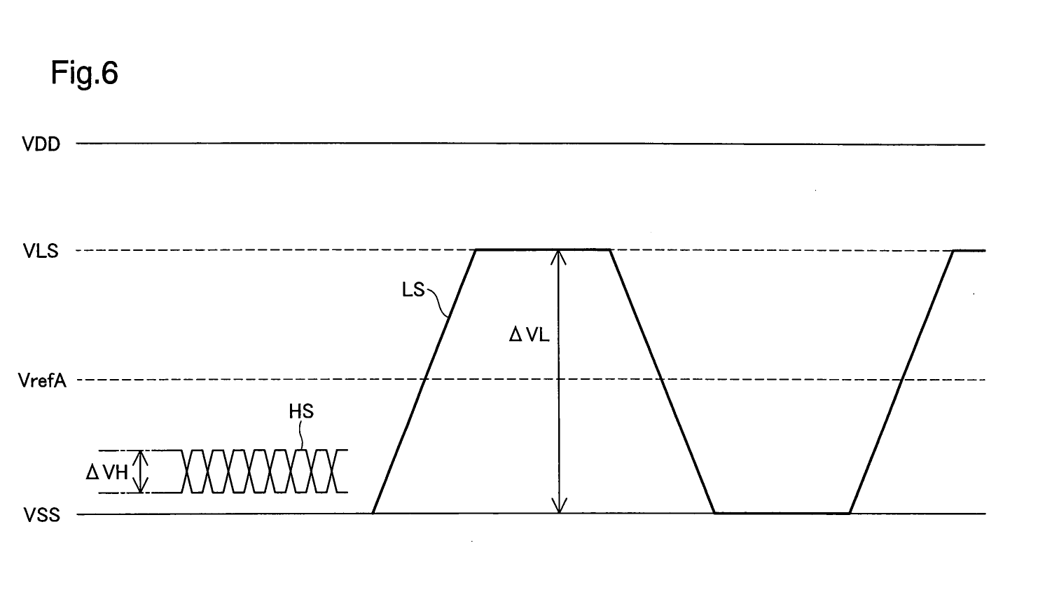

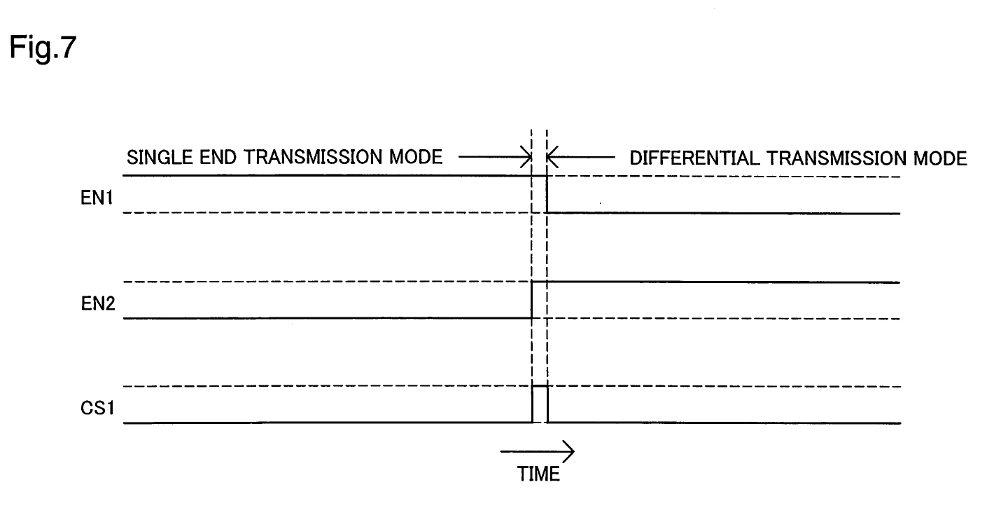

The operation of the data transmission circuit 2500a will be discussed with reference to FIGS. 5 through 7. FIG. 5 is a schematic diagram depicting state transitions of the data transmission circuit. FIG. 6 is a schematic diagram depicting differential signals and single end signals. FIG. 7 depicts a control signal timing chart.

As shown in FIG. 5, the data transmission circuit 2500a has as operating modes a differential transmission mode S1 for high-speed transmission of data HD by means of differential signals, and a single end transmission mode S2 for low-speed transmission of data LD by means of two single end signals. The amplitude ΔVH of the differential signals HS transmitted from the data transmission circuit 2500a in the differential transmission mode is set to about 200 mV, for example. Meanwhile, the single end signals LS transmitted from the data transmission circuit 2500a in the single end transmission mode include a low signal equal to the reference voltage VSS and a high signal equal to the adjusting voltage VLS (FIG. 6). The adjusting voltage VLS is generated using the step-down regulator 2540 mentioned earlier. The amplitude ΔVL (VLS−VSS) of the single end signal is set to a magnitude on the order of 4 to 10 times greater than the amplitude ΔVH of the differential signals, for example, to about 1.2 V.

The transmission rate of the differential signals HS is set to about 500 Mb/s (megabits/second) for example, while the transmission rate of the single end signals LS is set to about 10 Mb/s for example.

The reason that single end signals LS are used for low-speed data transmission and differential signals HS are used for high-speed data transmission in the embodiment will now be discussed. Transmission of the single end signals LS is performed by the push-pull circuit mentioned earlier, and the power consumption of this circuit increases in proportion to transmission rate. Also, the transmission rate cannot be increased to high speed with single end signals LS due to its characteristic.

Transmission of the differential signals HS, on the other hand, is performed by the differential amplification circuit mentioned earlier. Consumption of current by the differential amplification circuit does not change appreciably, regardless of whether the transmission rate is fast or slow. Moreover, with differential signals HS it is easier to increase the transmission rate than with single end signals LS. From this standpoint, it is more advantageous to employ differential signals HS for data transmission at relatively high transmission rates (e.g. 500 Mb/s). On the other hand, from a current consumption standpoint, it will sometimes be more advantageous to employ single end signals LS for data transmission at relatively low transmission rates (e.g. 10 Mb/s). For this reason, in the present embodiment, the single end signals LS and the differential signals HS are employed selectively, depending on the transmission speed.

Transitions between the differential transmission mode and the single end transmission mode in the data transmission circuit 2500a are controlled by means of the control signal CT1 from the transmission control circuit 2200. When the data transmission circuit 2500a is transitioning from the differential transmission mode S1 to the single end transmission mode S2, during the transition interval, potential on the signal line LP1 and on the signal line LN1 will be held at potential VLS (the High signal of the single end signals) for a prescribed time interval (FIG. 5: A1).

On the other hand, when the data transmission circuit 2500a transitions from the single end transmission mode S2 to the differential transmission mode S1, during the transition interval, a prescribed transition alert command will be transmitted to the receiving unit 1000 by means of the single end signals (FIG. 5: A2). The transition alert command is represented on about 3 to 8 bits of data, for example.

The receiving unit 1000 can verify transitions between operating modes in the transmitting unit 2000, by detecting these specific signals in the receiving unit 1000 during transition intervals between operating modes.

The discussion now continues, referring again to FIG. 7. When the data transmission circuit 2500a is operating in single end transmission mode S2, it is sufficient for the single end signal driver 2530 that transmits the single end signals LS to operate; it is not necessary for the differential driver 2520 that transmits the differential signals HS to operate.

For this reason, when the data transmission circuit 2500a is operating in single end transmission mode S2, the supply of power will be halted to circuits that relate to operation of the differential driver 2520, reducing power consumption. The supply of power to circuits relating to operation of the differential driver 2520 is controlled by the Enable signal EN2. Specifically, as shown in FIG. 7, the pre-driver 2510 of the data transmission circuit 2500a set the Enable signal EN2 Low (sets EN2X High), thereby halting function of the n transistor TR1 as the constant current supply CC1, as well as placing the bias circuit 2550 and the differential driver 2520 in the Disenabled state. In this state, the capacitor Cb assumes a non-charging state.

When the data transmission circuit 2500a is operating in single end transmission mode S2, power will be supplied to circuits that relate to operation of the single end driver 2530, placing the single end driver 2530 in the operation-enabled state. The supply of power to circuits relating to operation of the single end driver 2530 is controlled by an Enable signal EN1. Specifically, the pre-driver 2510 of the data transmission circuit 2500a set the Enable signal EN1 High, thereby placing the step-down regulator 2540 and the single end driver 2530 in the Enabled state. Once stabilized in this state, the capacitor Ca will assume a state of being charged by the adjusting voltage VLS output from the step-down regulator 2540.

On the other hand, when the data transmission circuit 2500a is operating in the differential transmission mode S1, it is sufficient for the differential driver 2520 that transmits the differential signals HS to operate; it is not necessary for the single end signal driver 2530 that transmits the single end signals LS to operate.

For this reason, when the data transmission circuit 2500a is operating in differential transmission mode S1, the supply of power will be halted to circuits that relate to operation of the single end signal driver 2530, reducing power consumption. Specifically, the pre-driver 2510 of the data transmission circuit 2500a will bring the Enable signal EN1 Low, thereby placing the step-down regulator 2540 in the Disenabled state and halting supply of the adjusting voltage VLS, as well as placing the single end signal driver 2530 in the Disenabled state. In this state, the capacitor Ca assumes a non-charging state.

When the data transmission circuit 2500a is operating in differential transmission mode S1, the differential driver 2520 assumes the operation-enabled state. Specifically, the pre-driver 2510 of the data transmission circuit 2500a set the Enable signal EN2 High (sets EN2X Low), thereby allowing the n transistor TR1 to function as the constant current supply CC1, as well as placing the bias circuit 2550 and the differential driver 2520 in the Enabled state. Once stabilized in this state, the capacitor Cb will assume a state of being charged by the reference potential Vref1 output from the bias circuit 2550.

Once stabilized in the single end transmission mode S2 or in the differential transmission mode S1, the pre-driver 2510 will bring the control signal CS1 Low, whereupon the n transistor TR3 switch will go OFF, and the electrode of the capacitor Ca and the electrode of the capacitor Cb will assume the disconnected state.

Next, control during the transition from the single end transmission mode S2 to the differential transmission mode S1 will be discussed. As shown in FIG. 7, during transition from the single end transmission mode S2 to the differential transmission mode S1, the pre-driver 2510 will first bring the control signal CS1 High while at the same time switching the aforementioned Enable signal EN2 from a Low to a High signal, whereupon the n transistor TR3 switch will go ON, creating a current-carrying state across the electrode of the capacitor Ca and the electrode of the capacitor Cb. As a result, according to the law of conservation of charge, some of the charge that was charging the capacitor Ca during operation in the single end transmission mode S2 will now migrate instantaneously in the direction indicated by the broken line arrow in FIG. 4 and be supplied to the capacitor Cb, thereby charging the capacitor Cb.

Next, after a very short time (e.g. several ns (nanoseconds)), the pre-driver 2510 will return the control signal CS1 from a High to a Low signal while at the same time switching the aforementioned Enable signal EN1 from a High to a Low signal, whereupon the n transistor TR3 switch will go OFF and the electrode of the capacitor Ca and the electrode of the capacitor Cb will be returned to the disconnected state. By means of control in the above manner, the data transmission circuit 2500a transitions from the single end transmission mode S2 to the differential transmission mode S1.

Control during the transition from the differential transmission mode S1 to the single end transmission mode S2 is the reverse of that during the transition from the single end transmission mode S2 to the differential transmission mode S1. The pre-driver 2510 will first bring the control signal CS1 High while at the same time switching the aforementioned Enable signal EN1 from a Low to a High signal, whereupon the n transistor TR3 switch will go ON, creating a current-carrying state across the electrode of the capacitor Ca and the electrode of the capacitor Cb. As a result, according to the law of conservation of charge, some of the charge that was charging the capacitor Cb during operation in the differential transmission mode S1 will now migrate in the direction opposite to that indicated by the broken line arrow in FIG. 4, and be supplied instantaneously to the capacitor Ca, thereby charging the capacitor Ca. Next, after a very short time (e.g. several ns (nanoseconds)), the pre-driver 2510 will return the control signal CS1 from a High to a Low signal while at the same time switching the aforementioned Enable signal EN2 from a High to a Low signal. By means of control in the above manner, the data transmission circuit 2500a transitions from the differential transmission mode S1 to the single end transmission mode S2.

The clock transmission circuit 2500b outputs the differential signals HS and the single end signals LS over the signal lines LP2 and LN2 via the terminals TP2 and TN2. In the differential transmission mode S1, the clock transmission circuit 2500b transmits in the form of differential signals HS the high speed clock HC supplied by the PLL circuit 2300; in this respect the circuit differs from the data transmission circuit 2500a, which transmits data HD as differential signals HS. In the single end transmission mode S2, the clock transmission circuit 2500b does not transmit any data for sending to the LCD driver 600. The data transmission circuit 2500a transmits as single end signals LS only control commands that are directed to the receiving unit (e.g. the transition alert command discusser earlier). The internal configuration of the clock transmission circuit 2500b is basically similar to the configuration of the data transmission circuit 2500a discussed with reference to FIGS. 3 and 4, and will therefore not be described in any detail. The operation of the clock transmission circuit 2500b is similar to the operation of the data transmission circuit 2500a discussed with reference to FIGS. 5 through 7, and will therefore not be described in any detail.

Configuration of the Receiving Unit:

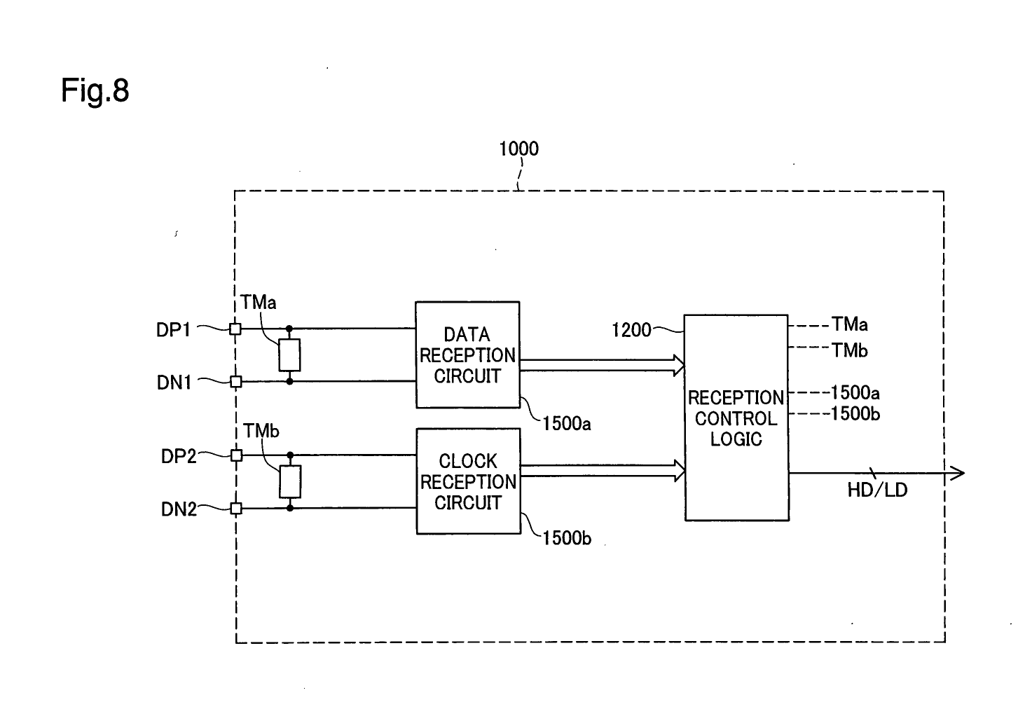

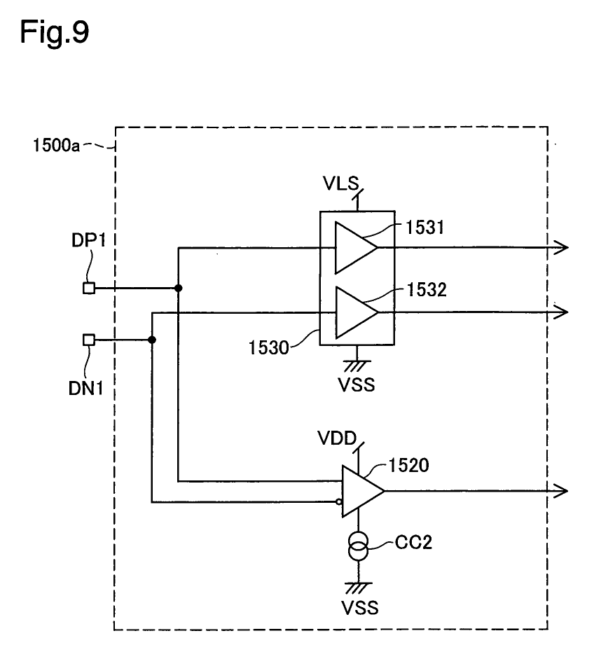

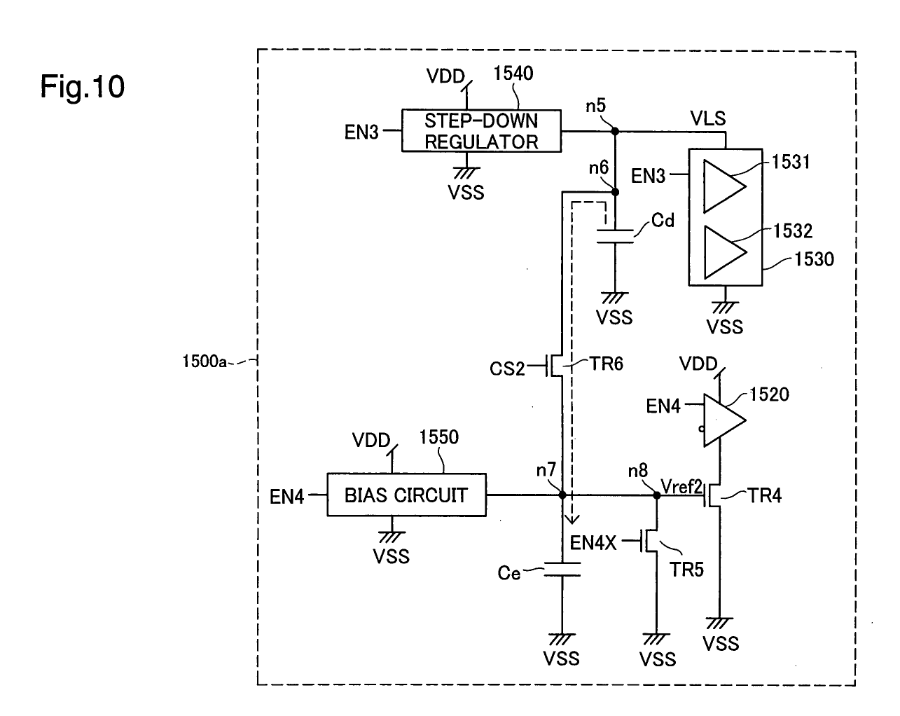

Next, the receiving unit 1000 which receives the differential signals HS and the single end signals LS from the aforementioned data transmitting unit 2000 via the signal lines LP1, LN1, LP2, LN2 will be discussed, with reference to FIGS. 8 through 10. FIG. 8 is an illustration depicting the internal configuration of the receiving unit. FIG. 9 is a diagram showing the principal constituent components of a data reception circuit. FIG. 10 is a diagram showing the data reception circuit power supply and vicinity.

As shown in FIG. 8, the receiving unit 1000 has termination circuits TMa, TMb; a data reception circuit 1500a; a clock reception circuit 1500b; and a reception control logic 1200.

The termination circuit TMa is a circuit for terminating the differential signals HS received via the terminal pair composed of the terminals DP1 and DN1. Under the control of the reception control logic 1200, upon receiving the differential signals HS the termination circuit TMa will connect the terminal DP1 and the terminal DN1 across termination resistance on the order of 100 Ω; and upon receiving the single end signals LS will respectively place the terminal DP1 and the terminal DN1 in a high impedance state.

The other termination circuit TMb is a circuit for terminating the differential signals HS received via the terminal pair composed of the terminals DP2 and DN2. The configuration of the termination circuit TMb is similar to that of the termination circuit TMa described above and requires no further description.

The reception control logic 1200 is a logic circuit that primarily carries out a serial/parallel conversion process that converts, from serial data to parallel data, signals received from the data reception circuit 1500a; and a so-called protocol process for extracting data HD and data LD from the parallel data and transferring the data to the LCD driver 600.

Using Enable signals EN3, EN4 to be discussed later, the reception control logic 1200 also controls the termination circuits TMa, TMb, the data reception circuit 1500a, and the clock reception circuit 1500b.

The data reception circuit 1500a is a circuit for receiving differential signals HS and single end signals LS that are received via the terminal pair composed of the terminals DP1 and DN1. As shown in FIG. 9, the data reception circuit 1500a has a single end receiver 1530, and a differential receiver 1520. The single end receiver 1530 includes a first receiver 1531 connected to the terminal DP1, and a second receiver 1532 connected to the terminal DN1; the single end signals LS are received independently from the respective terminals. The first receiver 1531 and the second receiver 1532 may employ a configuration furnished in the input stage with a CMOS inverted connected between the adjusting voltage VLS and the reference voltage VSS, for example.

The differential receiver 1520 is connected to the two terminals DP1 and DN1. The differential receiver 1520 has a configuration of known type with a differential amplification circuit as the principal component, and converts the differential signals HS input via the two terminals DP1 and DN1 (the signal line LP1 and the signal line LN1) into single end signals for output. Like the differential driver 2520, the differential receiver 1520 is disposed between the power supply voltage VDD and the reference voltage VSS, and is current-drive by means of a constant current supply CC2 likewise disposed between the power supply voltage VDD and the reference voltage VSS.

As shown in FIG. 10, the data reception circuit 1500a also has a step-down regulator 1540 and a bias circuit 1550.

The step-down regulator 1540 is a circuit similar to the step-down regulator 1540 of the data transmission circuit 2500a (FIG. 4); it steps down the input power supply voltage VDD (in the embodiment, 1.8 V) to the aforementioned adjusting voltage VLS (in the embodiment, 1.2 V) for output.

A capacitor Cd is disposed between the reference voltage VSS and a node n5 on the line over which the adjusting voltage VLS is output from the step-down regulator 1540 to the single end receiver 1530. The capacitor Cd is a bypass capacitor for the purpose of stabilizing operation of the single end receiver 1530.

The bias circuit 1550 uses the input power supply voltage VDD to generate a reference potential Vref2. The bias circuit 1550 is a circuit similar to the bias circuit 2550 of the data transmission circuit 2500a (FIG. 4), and consists of an ordinary band gap reference circuit, for example.

As shown in FIG. 10, an n transistor TR4 is disposed between the differential driver 1520 and the reference voltage VSS. The reference potential Vref2 is input to the gate of the n transistor TR4, whereby the n transistor TR4 functions as the constant current supply CC2 shown in FIG. 9.

Nodes n7 and n8 are disposed on the line over which the reference potential Vref2 is output from the bias circuit 1550 to the gate of the n transistor TR4. A capacitor Ce is disposed between the node n7 and the reference voltage VSS. The capacitor Ce is a bypass capacitor for the purpose of stabilizing the reference potential Vref2, and stabilizing the n transistor TR4 that functions as the constant current supply CC2. An n transistor TR5 is disposed between the node n8 and the reference voltage VSS. An inverted signal EN4X of an Enable signal EN4, discussed later, is input to the gate of the n transistor TR5, whereby the n transistor TR5 functions as a switch for switching, between an Enabled state and a Disenabled state, the n transistor TR 4 that functions as the constant current supply CC2.

The node n6 connected to the electrode of the capacitor Cd and the node n7 connected to the electrode of the capacitor Ce are interconnected via an n transistor TR6. A control signal CS2 is input to the gate of the n transistor TR6, whereby the n transistor TR6 functions as a switch for switching the connection between the capacitor Cd and the capacitor Ce between a current-carrying state and an disconnected state.

Operation of the Transmitting Unit:

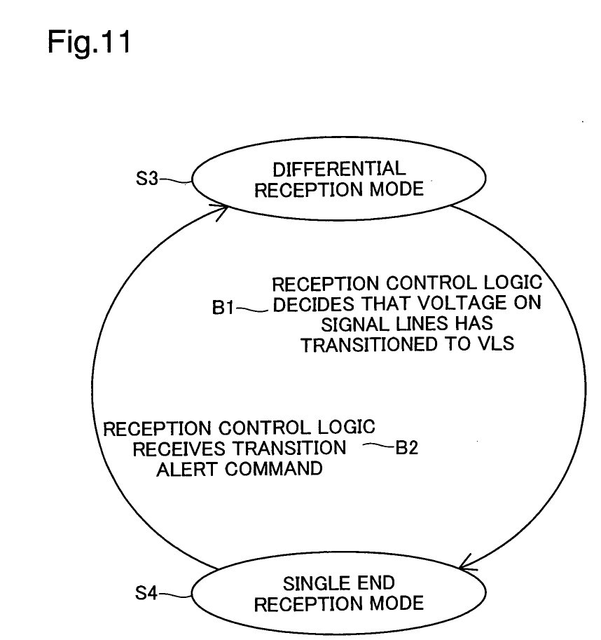

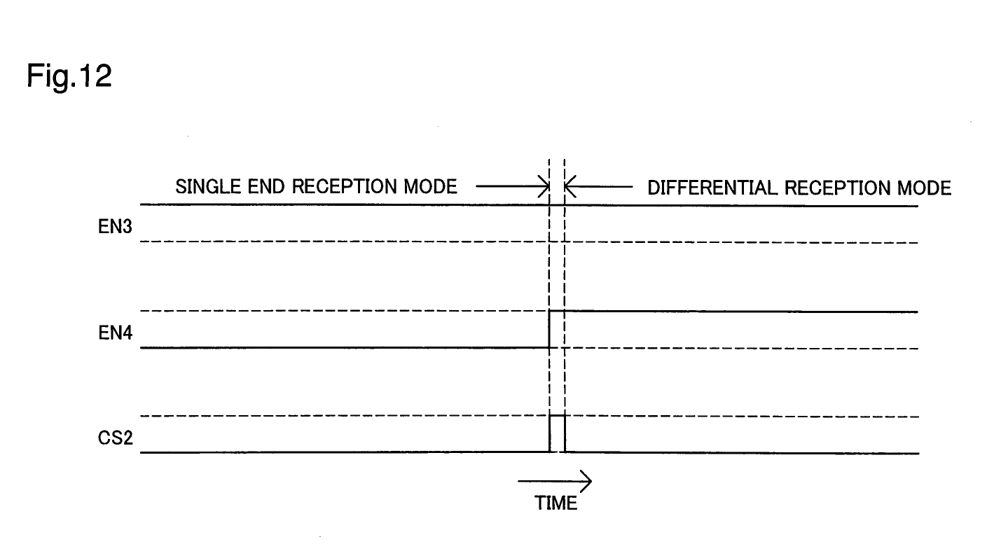

The operation of the data reception circuit 1500a will be discussed with reference to FIGS. 11 and 12. FIG. 11 is a schematic diagram depicting state transitions of the data reception circuit. FIG. 12 depicts a control signal timing chart.

As shown in FIG. 11, the data reception circuit 1500a receives signals in either of two reception modes, via the terminal pair composed of the terminals DP1 and DN1. The two reception modes are a differential reception mode S3 for receiving the differential signals HS described previously, and a single end reception mode S4 for receiving the single end signals described previously. These modes are controlled by the reception control logic 1200. In the event that the mode of the data reception circuit 1500a is the differential reception mode S3, if the reception control logic 1200 decides on the basis of output from the data reception circuit 1500a that the voltage on the terminal DP1 and the terminal DN1 (the voltage on the signal line LP1 and the signal line LN1) has changed to VLS level (FIG. 11: B1), the mode of the data reception circuit 1500a will be changed to the single end reception mode S4. Specifically, if the reception control logic 1200 has detected change of the mode of the data transmission circuit 2500a from the differential transmission mode S1 to the single end transmission mode S2, the mode of the data reception circuit 1500a will be changed from the differential reception mode S3 to the single end reception mode S4.

On the other hand, with the data reception circuit 1500a in the single end reception mode S4, if a specific transition alert command (prescribed data represented on about 3 to 8 bits of data, for example) included in the output of the data reception circuit 1500a is received (FIG. 11: B2), the mode of the data reception circuit 1500a will be changed to the differential reception mode S3. Specifically, if by receiving a transition alert command, the reception control logic 1200 has detected change of the mode of the data transmission circuit 2500a from the single end transmission mode S2 to the differential transmission mode S1, the mode of the data reception circuit 1500a will be changed from the single end reception mode S4 to the differential reception mode S3.

The discussion now continues, referring again to FIG. 10. When the data reception circuit 1500a is operating in the single end reception mode S4, it is sufficient for the single end receiver 1530 that receives the single end signals LS to operate; it is not necessary for the differential receiver 1520 that receives the differential signals HS to operate.

For this reason, when the data reception circuit 1500a is operating in single end reception mode S4, the supply of power will be halted to circuits that relate to operation of the differential receiver 1520, in order to reduce power consumption. The supply of power to circuits relating to operation of the differential receiver 1520 is controlled by the Enable signal EN4 from the reception control logic 1200. Specifically, the reception control logic 1200 set the Enable signal EN4 Low (sets EN4X High), thereby halting function of the n transistor TR4 as the constant current supply CC2, as well as placing the bias circuit 1550 and the differential receiver 1520 in the Disenabled state. In this state, the capacitor Ce assumes a non-charging state.

When the data reception circuit 1500a is operating in the single end reception mode S4, power is supplied to circuits relating to operation of the single end receiver 1530, placing the single end receiver 1530 in the operation-enabled state. The supply of power to circuits relating to operation of the single end receiver 1530 is controlled by the Enable signal EN3. Specifically, the reception control logic 1200 set the Enable signal EN3 High, thereby placing the step-down regulator 1540 and the single end receiver 1530 in the Enabled state. Once stabilized in this state, the capacitor Cd will assume a state of being charged by the adjusting voltage VLS output from the step-down regulator 1540.

On the other hand, when the data reception circuit 1500a is operating in the differential reception mode S3, it will be necessary for the differential receiver 1520 that receives the differential signals HS to be in operation, as well as for the single end receiver 1530 that receives the single end signals LS to be in operation. The single end receiver 1530 is needed for the purpose of detecting change of the data transmission circuit 2500a mode from the differential transmission mode S1 to the single end transmission mode S2 (change in voltage on the terminal DP1 and the terminal DN1 to VLS level) (see FIG. 11).

For this reason, when the data transmission circuit 2500a is operating in the differential reception mode S3, both the single end receiver 1530 and the differential receiver 1520 are in the operation-enabled state. Specifically, the reception control logic 1200 set the Enable signal EN3 High and places the step-down regulator 1540 and the single end receiver 1530 in the Enabled state, as well as setting the Enable signal EN4 High (setting EN4X Low), allowing the n transistor TR4 to function as the constant current supply CC2, and placing the bias circuit 1550 and the differential receiver 1520 in the Enabled state.

Once stabilized in the differential reception mode S3 or single end reception mode S4, a comparator 1510 will set the control signal CS2 Low, whereupon the n transistor TR6 switch will go OFF, and the electrode of the capacitor Ca and the electrode of the capacitor Cb will assume the disconnected state.

Next, control when transitioning from the single end reception mode S4 to the differential reception mode S3 will be discussed. As shown in FIG. 12, during transition from the single end reception mode S4 to the differential reception mode S3, the reception control logic 1200 will first bring the control signal CS2 High while at the same time switching the aforementioned Enable signal EN4 from a Low to a High signal, whereupon the n transistor TR6 switch will go ON, creating a current-carrying state across the electrode of the capacitor Cd and the electrode of the capacitor Ce. As a result, according to the law of conservation of charge, some of the charge that was charging the capacitor Cd during operation in the single end reception mode S4 will now migrate instantaneously in the direction indicated by the broken line arrow in FIG. 10 and be supplied to the capacitor Ce, thereby charging the capacitor Ce.

Next, after a very short time (e.g. several ns (nanoseconds)), the reception control logic 1200 will return the control signal CS2 from a High to a Low signal, thereby turning the n transistor TR6 switch OFF, and returning the electrode of the capacitor Cb and the electrode of the capacitor Ce to the disconnected state. By means of control in the above manner, the data reception circuit 1500a transitions from the single end reception mode S4 to the differential reception mode S3.

According to the digital device of the embodiment discussed hereinabove, in conjunction with a transition from the single end reception mode S4 to the differential reception mode S3 in the data reception circuit 1500a, during startup of the differential receiver 1520 and the bias circuit 1550 some of the electrical charge that was charging the capacitor Cd will be supplied to the capacitor Ce, thereby charging the capacitor Ce. As a result, for example, it will be possible to reduce the time required for charging the capacitor Ce, specifically, the interval from the time that the differential receiver 1520 and the bias circuit 1550 are started (from switching of the Enable signal EN4 from a Low to a High signal) until stable operation of the differential receiver 1520 and the bias circuit 1550 (i.e. the startup time).

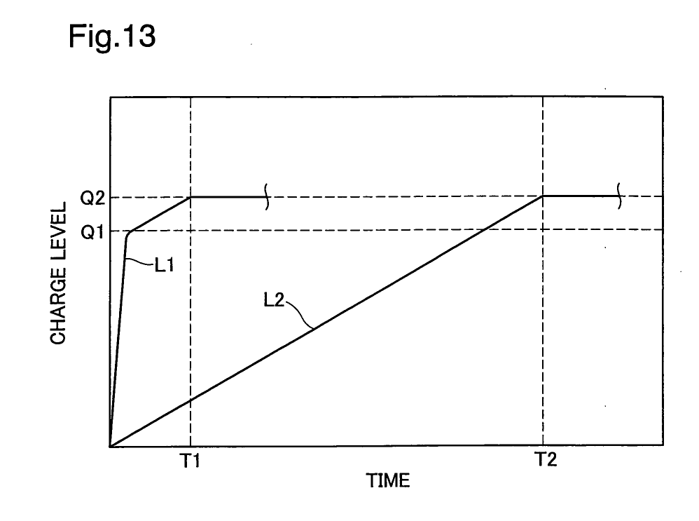

Further description will be made with reference to FIG. 13, in order to facilitate understanding. FIG. 13 is a graph illustrating startup time. In the graph of FIG. 13, the level of charge at which the capacitor Ce is charged is given on the vertical axis, and elapsed time since startup of the differential receiver 1520 and the bias circuit 1550 is given on the horizontal axis. The capacity of the capacitor Ce is denoted as Q2. In the graph of FIG. 13, by way of a comparative example, the case where the capacitor Ce is charged exclusively by current supplied from the bias circuit 1550 is depicted by line L2. In the comparative example, the capacitor Ce is charged at a rate dependent on the current-supplying capability of the bias circuit 1550, and is charged to its capacity Q2 after a time interval T2 has elapsed since startup. Specifically, the time interval T2 is the time interval up to stable operation of the differential receiver 1520 and the bias circuit 1550. The time interval T2 is on the order of 120 ns, for example.

On the other hand, the case where the capacitor Ce is charged by the method taught in the present embodiment is shown by line L1. As discussed previously, in the embodiment, simultaneously with startup of the differential receiver 1520 and the differential receiver 1520, some of the current that was charging the capacitor Cd will now be supplied to the capacitor Ce, charging the capacitor Ce. Migration of charge from the capacitor Cd to the capacitor Ce is completed within a very short time in comparison with time interval T2, for example, on the order of 1 ns. Where Q1 denotes the level of charge supplied to the capacitor Ce from the capacitor Cd, as shown in FIG. 13, the capacitor Ce is instantaneously charged with electrical charge of Q1, with the remaining charge (Q2−Q1) coming from current supplied by the bias circuit 1550. As a result, in the present embodiment, the capacitor Ce becomes charged to its capacity of Q2 after a time interval T1 shorter than the time interval T2 in the comparative example. From the preceding it will be apparent that the time interval until stabilization of operation of the differential receiver 1520 and the bias circuit 1550 (the startup time) is shorter in the case of the present embodiment. For, example, where the capacity of the capacitor Cd is sufficiently greater than the capacity Q2 of the capacitor Ce (e.g. twice as large or more) and the level of charge Q1 supplied from the capacitor Cd to the capacitor Ce is greater than Q2, the capacitor Ce can be charged instantaneously to its capacity Q2. In this case, the startup time of the differential receiver 1520 and the bias circuit 1550 can be made extremely short, for example.

Furthermore, according to the digital device of the present embodiment, in association with transition from the single end transmission mode S2 to the differential transmission mode S1 in the data transmission circuit 2500a, during startup of the differential driver 2520 and the bias circuit 2550 some of the current that was charging the capacitor Ca will now be supplied to the capacitor Cb, thereby charging the capacitor Cb. As a result, the startup time of the differential driver 2520 and the bias circuit 2550 can be reduced. Similarly, in association with transition from the differential transmission mode S1 to the single end transmission mode S2 to in the data transmission circuit 2500a, during startup of the single end driver 2530 and the step-down regulator 2540 some of the current that was charging the capacitor Cb will now be supplied to the capacitor Ca, thereby charging the capacitor Ca. As a result, for example, the startup time of the single end driver 2530 and the step-down regulator 2540 can be reduced.

Moreover, in the present embodiment, the shorter startup time discussed above can be achieved simply by providing a single n transistor as a switch, between the electrodes of the two capacitors. It is therefore possible to attain shorter startup time without any increase in the number of components or increase in the layout area, for example.

Furthermore, in the present embodiment, for example, power consumption can be reduced owing to the fact that the capacitors for stabilizing circuits being started up are charged using electrical charge supplied by other capacitors. For example, in association with transition from the single end transmission mode S2 to the differential transmission mode S1 in the data transmission circuit 2500a, during startup of the differential driver 2520 and the bias circuit 2550 some of the current that was charging the capacitor Ca will now be supplied to the capacitor Cb. Subsequently, in the differential transmission mode S1, the single end driver 2530 and the step-down regulator 2540 will be halted, rendering unnecessary the charge stored in the capacitor Ca; however, instead of being discharged, the charge is used for charging the capacitor Cb. In this case, it is therefore possible to hold down power consumption by the bias circuit 2550 for the purpose of charging the capacitor Cb.

Moreover, as in conventional practice, where it is attempted to reduce startup time through fast charging of the capacitors using active elements such as transistors, it has proven difficult to accurately control startup time owing to variability on the part of the active elements. In the present embodiment, however, since the capacitors for stabilizing the circuits being started up are charged using electrical charge supplied by other capacitors, reduced startup times can be attained with high accuracy, for example.

B. Modifications:

Modification 1:

In the preceding embodiment, the charge used to charge the capacitors for stabilizing circuits being started up is not limited to charge that is stored in the capacitors taught in the embodiment. For example, bypass capacitors are generally employed in the circuitry making up other units of a digital device, or in other circuits, not illustrated, besides those in the receiving unit 1000 and the transmitting unit 2000; and the charge stored in these bypass capacitors could be used instead. For example, provided that charge is stored in bypass capacitors of a circuit that is not currently in operation, that charge may be used for charging a capacitor for stabilizing a circuit being started up. In general terms, provided that a charge storage currently storing electrical charge is available at the time of startup of a targeted circuit, the electrical charge stored in that charge storage can be employed at the time of startup of the target circuit, in order to stabilize the target circuit.

Modification 2:

In the preceding embodiment, the capacitor for stabilizing a circuit is charged using electrical charge stored in a single capacitor, but it would be acceptable to use electrical charge stored in a plurality of capacitors instead. For example, charge stored in a plurality of capacitors disposed within a digital device could be collected and used to charge a capacitor for stabilizing a circuit being started up.

Modification 3:

In the preceding embodiment, an example of reducing the startup time of the differential receiver 1520 and the differential driver 2520 was described; however, the present invention is not limited thereto, and may be implemented for the purpose of reducing the startup time of any circuit furnished with a capacitor for stabilizing operation.

Modification 4:

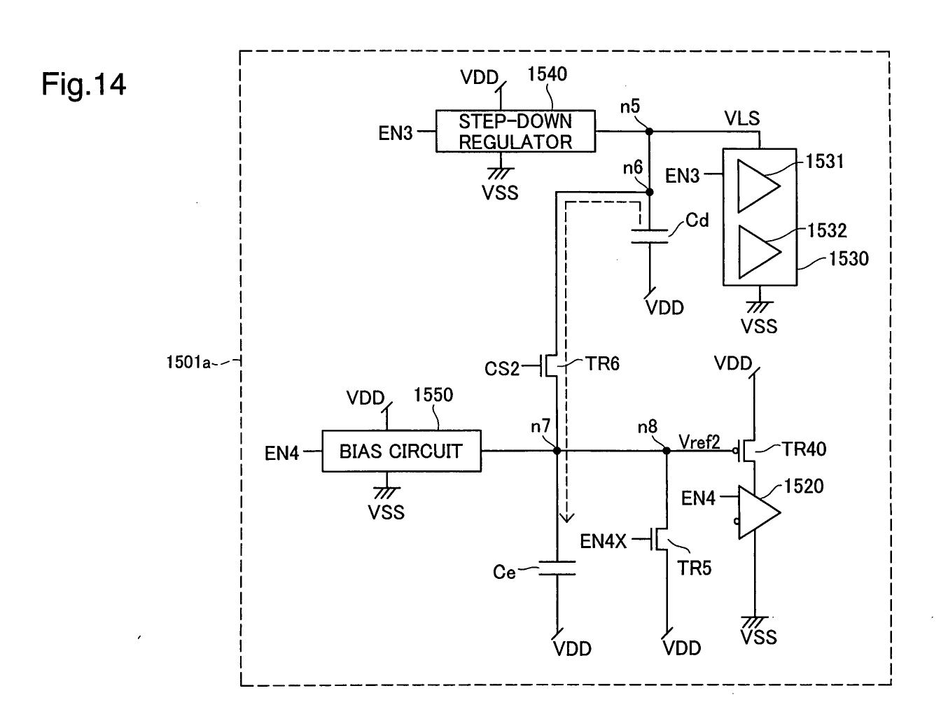

While the data reception circuit 1500a described in the preceding embodiment employed a topology (circuit configuration) in which the capacitor Cd is disposed between the regulator output node and the reference voltage VSS, and the capacitor Ce is disposed between the bias output node and the reference voltage VSS, respectively, these capacitors could instead be disposed between the output nodes and some kind of stable power supply. An example wherein these capacitors are disposed between the output nodes and the power supply voltage VDD will be described by way of Modification 4, with reference to FIG. 14. FIG. 14 is an illustration depicting the configuration of the vicinity of the power supply of the data reception circuit in Modification 4.

In place of the n transistor TR4 of the data reception circuit 1500a in the embodiment, the data reception circuit 1501a (FIG. 14) in Modification 4 is furnished with a p transistor TR40 as the transistor for inputting the reference potential Vref2 from the bias circuit 1550 and functioning as a constant current supply. The p transistor TR40 is disposed between the differential receiver 1520 and the power supply voltage VDD, rather than between the differential receiver 1520 and the reference voltage VSS.

Whereas in the data reception circuit 1500a (FIG. 10) of the embodiment, the capacitor Ce is disposed between the bias output node n7 and the reference voltage VSS, the data reception circuit 1501a in Modification 4 differs in that the capacitor Ce is instead disposed between the bias output node n7 and the power supply voltage VDD (FIG. 14).

Whereas in the data reception circuit 1500a (FIG. 10) of the embodiment, the capacitor Cd is disposed between the regulator output node n5 and the reference voltage VSS, the data reception circuit 1501a in Modification 4 differs in that the capacitor Ce is instead disposed between the regulator output node n5 and the power supply voltage VDD (FIG. 14).

Whereas in the data reception circuit 1500a of the embodiment, the n transistor TR5 to whose gate is input the inverted signal EN4X of the Enable signal EN4 and which functions as an Enable switch is disposed between the bias output node n8 and the reference voltage VSS, the data reception circuit 1501a in Modification 4 differs in that the n transistor TR5 is disposed between the bias output node n8 and the power supply voltage VDD (FIG. 14).

In other respects the configuration of the data reception circuit 1501a in Modification 4 is identical to the configuration of the data reception circuit 1500a of the embodiment, and requires no further discussion.

A digital device employing the data reception circuit 1501a of Modification 4 will have operation and effects analogous to the digital device of the embodiment.

The capacitors Ca and Cb in the data transmission circuit 2500a are not limited to being disposed between the output nodes and the reference voltage VSS (FIG. 4), and may instead be disposed between the output nodes and some kind of stable power supply. For example, these capacitors may be disposed between the output nodes and the power supply voltage VDD, as in the data reception circuit 1500a of Modification 4 (FIG. 14).

Modification 5:

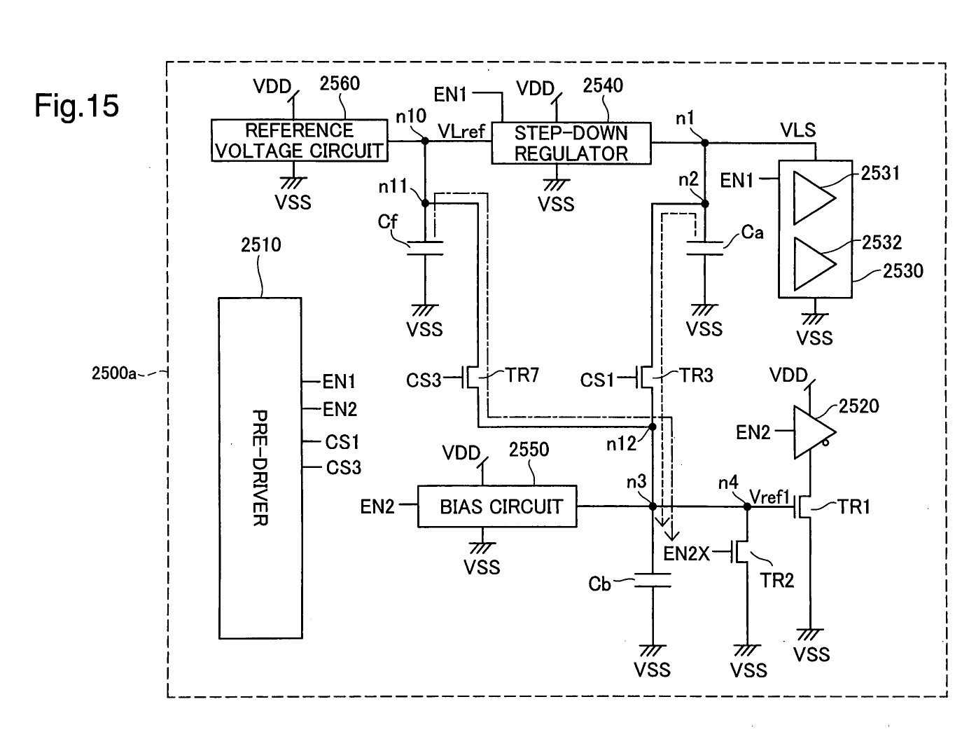

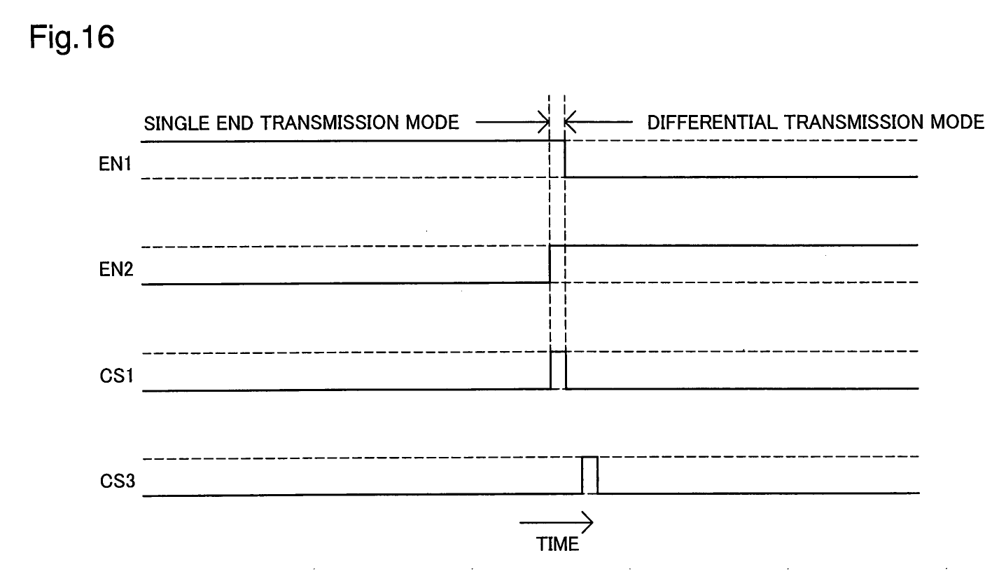

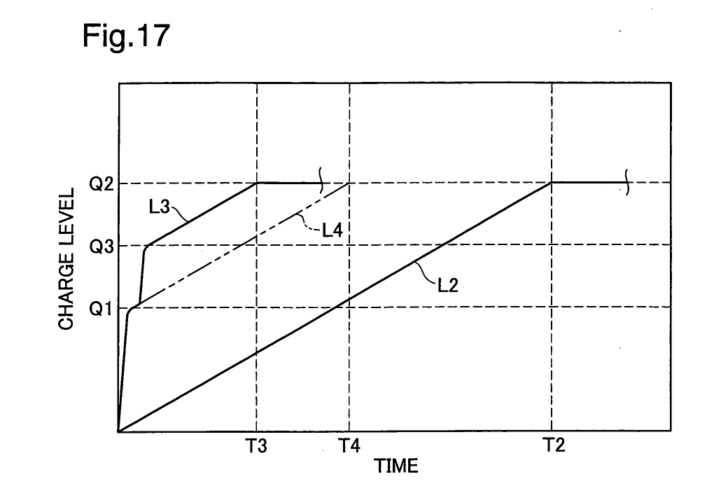

In the data transmission circuit 2500a in above-mentioned embodiment, the electrical charge stored in the capacitor Ca is used to charge the capacitor Cb at the time of the startup of the differential transmission mode S1. However, electrical charges stored in other circuit or device may be used to charge the capacitor Cb in addition to the electrical charge stored in the capacitor Ca. Its specific example will be described as Modification 5 with reference to FIGS. 15 to 17. FIG. 15 is a diagram showing the data transmission circuit power supply and vicinity in Modification 5. FIG. 16 depicts a control signal timing chart in Modification 5. FIG. 17 is a graph illustrating startup time in Modification 5.

It is omitted in FIG. 4 used for description of above-mentioned embodiment, however, the data transmission circuit 2500a includes a reference voltage circuit 2560 which supplies the step-down regulator 2540 with reference voltage VLref that is the reference of the adjusting voltage VLS (FIG. 15). The reference voltage circuit 2560 is, for example, a circuit including an ordinary band gap reference circuit. A capacitor Cf is disposed between the reference voltage VSS and an node 10 disposed on the line over which the VLref is output from the reference voltage circuit 2560 to the step-down regulator 2540. The capacitor Cf is a bypass capacitor for the purpose of stabilizing the VLref, and stabilizing the operation of the step-down regulator 2540.

In the data transmission circuit 2500a in Modification 5, the electrical charge stored in the capacitor Cf, in addition to the electrical charge stored in the capacitor Ca, is used to charge the capacitor Cb. As shown in FIG. 15, in the data transmission circuit 2500a, therefore, a node n11 connected to the electrode of the capacitor Cf and a node n12 connected to the electrode of the capacitor Cb are interconnected via an n transistor TR7. A control signal CS3 is input to the gate of the n transistor TR7, whereby the n transistor TR7 functions as a switch for switching the connection between the electrode of the capacitor Cf and the electrode of the capacitor Cb between a current-carrying state and an disconnected state.

Operation of Transmitting Unit:

When the data transmission circuit 2500a is operating in the single end transmission mode S2, the step-down regulator 2540 and reference voltage circuit 2560 is operating, and the capacitor Ca and the capacitor Cf assume charging states respectively. On the other hand, the bias circuit 2550 and the differential driver 2520 are not operating and the capacitor Cb assumes a non-charging state.

During transition from the single end transmission mode S2 to the differential transmission mode S1, same as the embodiment, the pre-driver 2510 will first bring the control signal CS1 High while at the same time switching the Enable signal EN2 from a Low to a High signal, whereupon the n transistor TR3 switch will go ON, creating a current-carrying state across the electrode of the capacitor Ca and the electrode of the capacitor Cb. As a result, according to the law of conservation of charge, some of the charge that was charging the capacitor Ca during operation in single end transmission mode S2 will now migrate instantaneously in the direction indicated by the broken line arrow in FIG. 15 and be supplied to the capacitor Cb, thereby charging the capacitor Cb.

Next, after a very short time (e.g. several ns (nanoseconds)), pre-driver 2510, same as the embodiment, will return the control signal CS1 from a High to a Low signal at the same time switching the Enable signal EN1 from a High to a Low signal, thereby turning the n transistor TR3 as a first switch OFF, and returning the electrode of the capacitor Ca and the electrode of the capacitor Cb to the disconnected state.

As shown in FIG. 16, the pre-driver 2510 further bring the control signal CS3 a High signal from a Low signal shortly after returning the control signal CS 1 from a High to a Low signal, thereby turning the n transistor TR7 as a second switch ON, creating a current-carrying state across the electrode of the capacitor Cf and the electrode of the capacitor Cb. As a result, according to the law of conservation of charge, some of the charge that was charging the capacitor Cf during operation in single end transmission mode S2 now migrates instantaneously in the direction indicated by the one point broken line arrow in FIG. 15 and be supplied to the capacitor Cb, thereby further charging the capacitor Cb. After a very short time, pre-driver 2510, will return the control signal CS3 from a High to a Low signal, thereby turning the n transistor TR7 as a second switch OFF, and returning the electrode of the capacitor Cf and the electrode of the capacitor Cb to the disconnected state. As just described, in Modification 5, at the time of startup of the differential driver 2520 and the bias circuit 2550, the electrical charge stored in the capacitor Ca and the electrical charge stored in the capacitor Cf are supplied to the capacitor Cb at different timings just staggered by a very short time (e.g. several ns (nanoseconds)).

According to Modification 5 described above, during a transition from the single end transmission mode S2 to the differential transmission mode S1, it will be possible to further reduce the time required for charging the capacitor Cb. As a result, the startup time of the differential driver 2520 and the bias circuit 2550 can be shortened additionally.

Further description will be made with reference to FIG. 17, in order to facilitate understanding. In the graph of FIG. 17, the level of charge at which the capacitor Cb is charged is given on the vertical axis, and elapsed time since startup of the differential driver 2520 and the bias circuit 2550 is given on the horizontal axis. The capacity of the capacitor Cb is denoted as Q2. In the graph of FIG. 17, by way of a comparative example, the case where the capacitor Cb is charged exclusively by current supplied from the bias circuit 2550 is depicted by line L2. In the comparative example, the capacitor Cb is charged at a rate dependent on the current-supplying capability of the bias circuit 2550, and is charged to its capacity Q2 after a time interval T2 has elapsed since startup. Specifically, the time interval T2 is the time interval up to stable operation of the differential driver 2520 and the bias circuit 2550. The time interval T2 is on the order of 120 ns, for example.

In the graph of FIG. 17, the case where the electrical charge stored in the capacitor Ca is used to charge the capacitor Cb, same as the above-mentioned embodiment, is also depicted by two-point broken line L4. Where Q1 denotes the level of charge supplied to the capacitor Cb from the capacitor Ca, as shown in FIG. 17, the capacitor Cb is instantaneously charged with electrical charge of Q1, with the remaining charge (Q2−Q1) coming from current supplied by the bias circuit 2550. As a result, the capacitor Cb becomes charged to its capacity of Q2 after a time interval T4 shorter than the time interval T2 in the comparative example.

In FIG. 17, the case where the capacitor Cb is charged by the means described as Modification 5 is also depicted by line L3. Quantity of electric charge supplied from the capacitor Cf to the capacitor Cb is (Q3−Q1). As shown in FIG. 17, at first, it is instantaneously charged with electrical charge Q1 from the capacitor Ca, and then it is instantaneously charged with electrical charge (Q3−Q1) from the capacitor Cf additionally. As a result, during a short time the capacitor Cb is charged with electrical charge Q3, with the remaining charge (Q2−Q3) coming from current supplied by the bias circuit 2550. As a result, in Modification 5 the capacitor Cb becomes charged to its capacity of Q2 after a time interval T3 shorter than the time interval T2 in the comparative example and T4 in the embodiment. From the preceding, for example, it will be apparent that the time interval until stabilization of operation of the differential driver 2520 and the bias circuit 2550 (the startup time) is further shorter in the case of the present modification.

In Modification 5, an example of the data transmission circuit 2500a was described, however, the means to charge a bypass capacitor in another circuit using electrical charge stored in a plurality of bypass capacitors may be implemented for the clock transmission circuit 2500b, the data reception circuit 1500a and the clock reception circuit 1500b. For example, in above-mentioned data reception circuit 1500a, during transition from single end reception mode S4 to differential reception mode S3, electrical charge stored in a plurality of bypass capacitors which are charged in single end reception mode S4 is used to charge the capacitor Ce shown in FIG. 10.

Other Modifications:

In the preceding embodiment and modifications, the transmitting and receiving system composed of the receiving unit 1000 and the transmitting unit 2000 is employed as an interface between the image processing unit 500 and the LCD driver 600, but is not limited thereto. The transmitting and receiving system could instead by employed as an interface for communications of various kinds, for example, for communication between chips, communication between boards, or communication between various types of device modules, or for internal communication in a backplane adapted for installation of circuit boards.

In the preceding embodiment and modifications, the digital device includes the liquid crystal display 700 and the transmitting/receiving system including the data transmitting unit 2000 and the receiving unit 1000 is used to transfer the signals for driving the liquid crystal display 700. Instead of liquid crystal display 700, other displays such as organic light emitting display or plasma display may be adopted, or various electro-optical devices such as a drive head of a laser printer may be adopted.

While the transmitting/receiving system in the preceding embodiment and modifications is furnished with a single pair of signal lines for data transmission (LP1, LN1) and a single pair of signal lines for clock transmission (LP2, LN2), it is not limited thereto. For example, it would be possible to instead provide a plurality of signal line pairs for data transmission, and a single pair of signal lines for clock transmission. Regardless of the particular configuration, each pair of signal lines will be provided on the receiving unit end with an arrangement corresponding to the data reception circuit 1500a in the preceding embodiment, and on the transmitting unit end with an arrangement corresponding to the data transmission circuit 2500a in the preceding embodiment.

While the 1500 of the transmitting and receiving system in the preceding embodiment and modifications is a unidirectional communication system in which the transmitting end and the receiving end are fixed, the invention could instead be implemented in a bidirectional communication system. In this case, transceivers having the functions of the data reception circuit 1500a and the data transmission circuit 2500a would be disposed at either end of the signal line LP1 and the signal line LN1.

While the present invention has been shown herein through certain embodiment and modifications, the embodiment and modifications set forth herein are intended to aid in understanding the invention and should not be construed as limiting of the invention. Various modifications and improvements to the invention are possible without departing from the spirit and scope thereof as recited in the appended claims, and shall be considered to be included among the equivalents of the present invention.

1. A unit including one or more circuits, the unit comprising:
a first circuit;
a first capacitor for stabilizing operation of the first circuit;
a charge storage that stores an electrical charge prior to startup of the first circuit; and
a charge supplier that charges the first capacitor at the time of startup of the first circuit, by means of supplying the first capacitor with the electrical charge stored in the charge storage.

2. A unit according to claim 1 further comprising
a second circuit,
wherein the charge storage is a second capacitor for stabilizing operation of the second circuit.

3. A unit according to claim 2,
wherein in the event that the second circuit is started up when the first capacitor is charged, the charge supplier additionally charges the second capacitor by means of supplying the second capacitor with the electrical charge stored in the first capacitor.

4. A unit according to claim 2,
wherein the unit operates in a first operation mode involving operation of the first circuit, or a second operation mode involving operation of the second circuit, and
wherein when operation of the unit transitions from the second operation mode to the first operation mode, the charge supplier charges the first capacitor by means of supplying the first capacitor with the electrical charge stored in the second capacitor.

5. A unit according to claim 4,
wherein when operation of the unit transitions from the second mode to the first mode, the charge supplier additionally charges the second capacitor by means of supplying the second capacitor with the electrical charge stored in the first capacitor.

6. A unit according to claim 2, wherein
the charge supplier includes:
a switch for switching a connection between an electrode of the first capacitor and an electrode of the second capacitor between a current-carrying state and a disconnected state; and
a controller that controls the switch.

7. A unit according to claim 1,
wherein the first capacitor is a bypass capacitor connected to a line for stabilizing a constant voltage, the line being for supplying the constant voltage with the first circuit.

8. A unit according to claim 2,
wherein the second capacitor is a bypass capacitor connected to a line for stabilizing a constant voltage, the line being for supplying the constant voltage with the second circuit.

9. A unit according to claim 1,
wherein the unit is a transmitting/receiving unit for transmitting/receiving signals with another unit.

10. A unit according to claim 9,
wherein the first circuit includes a circuit for transmitting or receiving a first signal; and
the second circuit includes a circuit for transmitting or receiving a second signal, the second signal being slower than the first signal.

11. A device including a unit according to claim 9, and a display driver that drives a display using the signal received by the unit.

12. A device including a unit according to claim 9, and a driver that drives an electro-optical device using the signal received by the unit.

13. A transmitting/receiving system including a first transmitting/receiving unit and a second transmitting/receiving unit interconnected via signal lines,
wherein either the first transmitting/receiving unit or the second transmitting/receiving unit is a unit according to claim 9.

14. A unit including one or more circuits, the unit comprising:
a first circuit;
a first capacitor for stabilizing operation of the first circuit;
a plurality of charge storages that store electrical charges prior to startup of the first circuit; and
a charge supplier that charges the first capacitor at the time of startup of the first circuit, by means of supplying the first capacitor with the electrical charges stored in each of the plurality of charge storages at different timings.

15. A unit according to claim 14, further comprising:
a second circuit; and
a third circuit,
wherein the plurality of charge storages includes a second capacitor for stabilizing operation of the second circuit and a third capacitor for stabilizing operation of the third circuit.

16. A unit according to claim 15, wherein
the charge supplier includes:
a first switch for switching a connection between an electrode of the first capacitor and an electrode of the second capacitor between a current-carrying state and a disconnected state;
a second switch for switching a connection between an electrode of the first capacitor and an electrode of the third capacitor between a current-carrying state and a disconnected state; and
a controller that controls the first switch and the second switch.

17. A unit according to claim 14,
wherein the first capacitor is a bypass capacitor connected to a line for stabilizing a constant voltage, the line being for supplying the constant voltage with the first circuit.

18. A unit according to claim 15,
wherein the second capacitor is a bypass capacitor connected to a line for stabilizing a constant voltage, the line being for supplying the constant voltage with the second circuit, and
wherein the third capacitor is a bypass capacitor connected to a line for stabilizing a constant voltage, the line being for supplying the constant voltage with the third circuit.

19. A unit according to claim 14,
wherein the unit is a transmitting/receiving unit for transmitting/receiving signals with another unit.

20. A unit according to claim 19,
wherein the first circuit includes a circuit for transmitting or receiving a first signal; and
the second circuit includes a circuit for transmitting or receiving a second signal, the second signal being slower than the first signal.

21. A control method related to a first circuit, the method comprising:
charging a charge storage prior to startup of the first circuit; and
charging a first capacitor for stabilizing operation of the first circuit at the time of the startup of the first circuit, by means of supplying the first capacitor with the electrical charge stored in the charge storage.

22. A control method related to a first circuit, the method comprising:
charging a plurality of charge storages prior to startup of the first circuit; and
charging a first capacitor for stabilizing operation of the first circuit at the time of the startup of the first circuit, by means of supplying the first capacitor with the electrical charges stored in each of the plurality of charge storages at different timings.
